(19) United States
(12) Patent Application Publication
(10) Pub. No.: US 2006/0105799 A1
(43) Pub. Date: May 18, 2006

(54) Portable telephone

(75) Inventors: Naoki Kobayashi, Tokyo (JP); Eiji Hankui, Tokyo (JP)

Correspondence Address: FOLEY AND LARDNER LLP;SUITE 500, 3000 K STREET NW, WASHINGTON, DC, 20007, US

(73) Assignee: NEC Corporation

(21) Appl. No.: 10/540,573

(22) PCT Filed: Dec. 25, 2003
(86) PCT No.: PCT/JP03/16717

§ 371 Date: Jun. 24, 2005

(30) Foreign Application Priority Data
Dec. 25, 2002 (JP) 2002-375609

(51) Int. Cl. H04M 1/00

(52) U.S. Cl. 455/550.1

(57) ABSTRACT

A portable phone comprises an upper casing 11 provided with a speaker 14 and a display screen 15, a lower casing 12 on which a keyboard is disposed 18, and an antenna 16 mounted on an upper end of the upper casing 11 or a lower end of the lower casing 12. A dielectric member 17 with a predetermined dielectric constant and little loss is mounted on a back side or a front side of the antenna 16. The dielectric member 17 may have a curved surface on a side opposite to the antenna 16.

### TECHNICAL FIELD

The present invention relates to a portable telephone, and in particular, it relates to a portable telephone having improved antenna-based communication performance.

### BACKGROUND ART

Compact and built-in antennas are now in increasing demand as recent portable telephones are decreased in size. Known portable telephone antennas include linear antennas such as a monopole antenna, a helical antenna, and an inverted-L-shape antenna.

FIGS. 14A and 14B are a front view and a side view of a related-art folding portable telephone, respectively, as an example. As shown in FIGS. 14A and 14B, the related-art portable telephone 60 includes an upper casing 11 and a lower casing 12 that construct the body of the portable telephone 60, a hinge 13 that joins the upper casing 11 and the lower casing 12 so as to fold or open the portable telephone body, and an antenna 16 for transmission and reception provided to the upper casing 11. The upper casing 11 includes a speaker 14 and a display screen 15 in addition to an internal circuit. The lower casing 12 includes a keyboard 18 and a microphone 19 in addition to an internal circuit. Although the antenna 16 is generally disposed at the upper end of the upper casing 11, it may be disposed at the lower end. The antenna 16 is fixed in length but may be varied in length.

The casing accommodates a printed circuit board (not shown), and has a transmission section for supplying transmission power, a power transmission section that transmits the power to the antenna, and a power amplifier that amplifies the power on the circuit board. The transmission power is generally sent from the output terminal of the power amplifier to the antenna 16 via a feeding section.

FIGS. 15A to 15C are diagrams of concrete examples of the linear antenna. As shown in FIGS. 15A to 15C, linear antennas 16a to 16c are a monopole antenna, a helical antenna, and an inverted-L-shape antenna from the top. The monopole antenna 16a and the helical antenna 16b, shown in FIGS. 15A and 15B, respectively, are mounted on the top of the portable telephone casing in such a manner that they project therefrom; the inverted-L-shape antenna 16c shown in FIG. 15C is mounted along the top or bottom of the casing, having a structure suitable for a built-in antenna.

FIGS. 16A and 16B are front view and side view of another related-art folding portable telephone, respectively. As shown in FIGS. 16A and 16B, the portable telephone 70 has an antenna built-in structure, in which an upper casing 21 including a printed circuit board 24 and a lower casing 22 including a printed circuit board 24 are joined together with a hinge 23. The portable telephone 70 has an inverted-L-shaped antenna 26 built in the lower casing 22.

Since portable telephones are decreasing in size as compact and built-in antennas are increasingly provided, the relative distance between the head or hand of a talker and the antenna is decreased, so that part of electricity radiated from the antenna during talking is absorbed by the head or hand of the talker, so that the communication performance of telephones tends to decrease.

In order to overcome the problem, conventional portable telephone technology has proposed a method for preventing the decrease in communication performance by a structure in which an antenna which is reduced in size by decreasing the wavelength owing to the use of a dielectric member is disposed at a position higher than a portable telephone casing via a rod so that the distance between a human body and the antenna is increased. Such a method is disclosed, for example, in Japanese Unexamined Patent Application Publication No. 2001-94323 (P. 3, FIG. 1).

However, such a structure and a method are not suitable for decreasing the size of portable telephones including an antenna and having an antenna built-in, because the shape is the same as that of a common dipole antenna having a small antenna thereon.

The above-described related-art portable telephone have the problem of difficulty in maintaining communication performance as portable telephones if the antennas are made more compact or built in.

### DISCLOSURE OF INVENTION

The present invention has been made to solve the above problems, and has as a first object the provision of a portable telephone having a structure suitable for miniaturization and having a built-in antenna, and as a second object the provision of a portable telephone having higher communication performance during talking with such a structure.

A portable telephone according to the present invention is characterized in that a dielectric member with a relatively high dielectric constant and little loss is mounted to the part of an antenna adjacent to the head of a talker, or at a position opposite to a part covered by the palm of the hand, wherein electromagnetic fields due to transmitted and received electric waves are concentrated on the dielectric member, or in some cases, a curved surface is provided on the dielectric member, thereby allowing electromagnetic waves to pass therethrough to provide a directivity opposite to the human body.

Other objects, structures, and advantages of the present invention will be more apparent by referring to the following description.

### BRIEF DESCRIPTION OF THE DRAWINGS

FIGS. 1A and 1B are a front view and a side view of a portable telephone according to a first embodiment of the present invention, respectively;

FIGS. 2A and 2B are a front view and a side view of a portable telephone according to a second embodiment of the present invention, respectively:

FIG. 3 is a side view of a portable telephone according to a third embodiment of the present invention;

FIG. 4 is a side view of a portable telephone according to a fourth embodiment of the present invention;

FIGS. 5A to 5C are diagrams showing various shaped dielectric members used in FIGS. 1 to 4;

FIG. 6 is an explanatory diagram of the three-dimensional orthogonal coordinates of a linear antenna model for explaining the principle of the present invention;

FIG. 7 is a characteristic diagram of the amount of electromagnetic energy plotted against the relative dielectric constant of FIG. 6;

FIG. 8 is an enlarged view of a dielectric member for explaining a refraction phenomenon around the critical angle of electromagnetic waves radiated from the antenna to a finite-thickness dielectric member in FIG. 6;

FIG. 9 is an enlarged view of a dielectric member for explaining a reflection and refraction phenomenon at the end of the dielectric member caused by a surface wave component traveling in the dielectric member in FIG. 8;

FIG. 10 is an enlarged view of a dielectric member for explaining a direction in which an electromagnetic wave travels when the dielectric member in FIG. 6 has a curved surface;

FIGS. 11A and 11B are a front view and a side view of a portable telephone for explaining a simulation model in which an inverted-L-shaped antenna is used in FIGS. 3 and 4;

FIG. 12 is a perspective view of a portable telephone for explaining the simulation model in which the palm and fingers of the talker are imitated in FIG. 11;

FIG. 13 is a characteristic diagram of the relationship between relative dielectric constants and electromagnetic radiation efficiencies for explaining the analysis of the simulation model in FIGS. 11 and 12;

FIGS. 14A and 14B are a front view and a side view of a related-art folding portable telephone, respectively;

FIGS. 15A to 15C are diagrams of concrete examples of common linear antennas; and

FIGS. 16A and 16B are a front view and a side view of another related-art folding portable telephone, respectively.

### BEST MODE FOR CARRYING OUT THE INVENTION

Embodiments of the present invention will be described hereinbelow.

A portable telephone according to the present invention includes a dielectric member having a relatively high relative dielectric constant and little loss in the vicinity of an antenna and opposite to a part covered with the head or the flat part of the hand of a talker, the electromagnetic field of a near-field region is concentrated on the dielectric member section, and in some cases, the dielectric member is given a curved surface, allowing electromagnetic waves to pass through outward to provide a directivity opposite to the human body, thus achieving an antenna with a small power loss due to a human body. This provides a portable telephone that has an antenna gain higher than that of conventional ones, improving the talking characteristic as a portable telephone.

Embodiments of the present invention will be described with reference to the drawings.

### FIRST EMBODIMENT

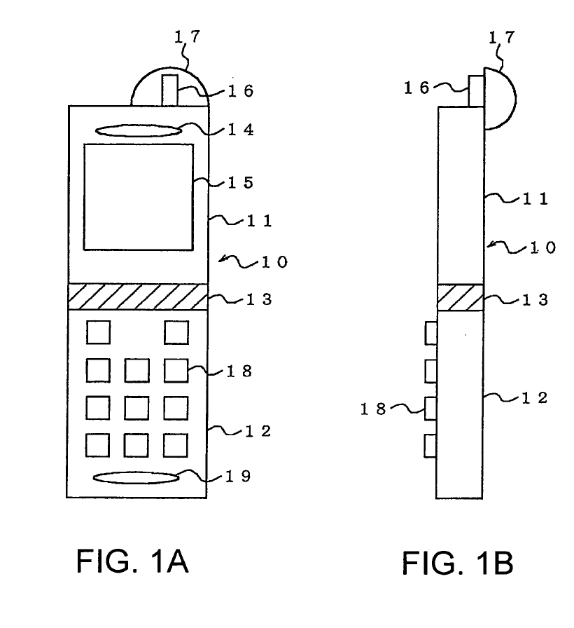

FIGS. 1A and 1B are a front view and a side view of a portable telephone according to a first embodiment of the present invention. As shown in FIGS. 1A and 1B, a portable telephone 10 according to this embodiment includes an upper casing 11 and a lower casing 12 that construct the body of the portable telephone, a hinge 13 that joins the upper casing 11 and the lower casing 12 so as to fold or open the portable telephone body, an antenna 16 for transmission and reception provided to the upper casing 11, and a dielectric member 17 disposed on the back of the antenna 16. The dielectric member 17 reduces a power loss due to the head of a talker to improve communication performance.

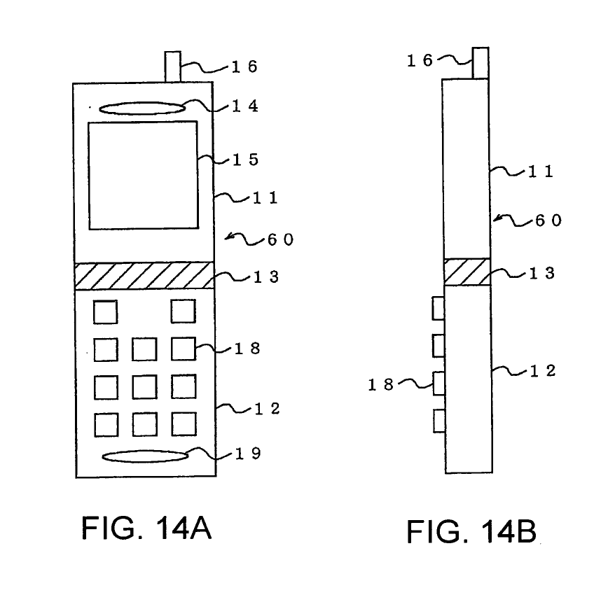

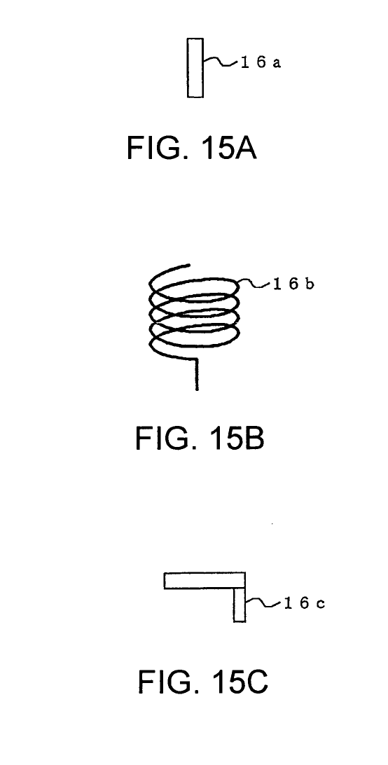

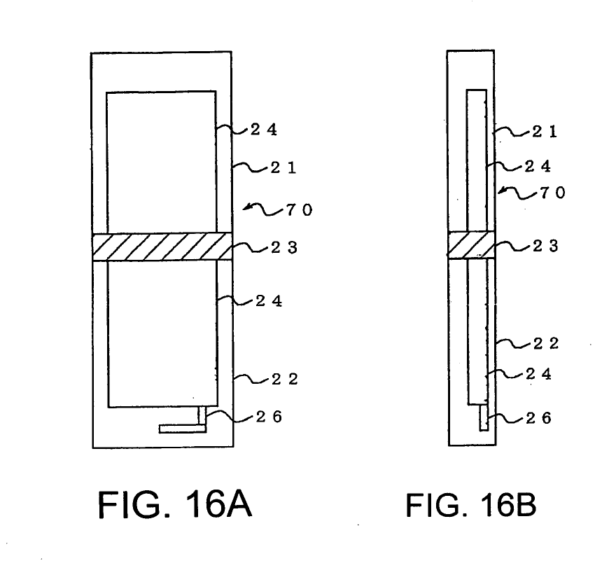

The upper casing 11 includes a speaker 14 and a display screen 15 in addition to an internal circuit, and the lower casing 12 includes a keyboard 18 and a microphone 19 in addition to an internal circuit, as in the above-described related art (FIG. 14).

Although the antenna 16 is generally disposed at the upper end of the upper casing 11, it may be disposed at the lower end. The antenna 16 is fixed in length but may be varied in length.

The casing accommodates a printed circuit board (not shown), and has a transmission section for supplying transmission power, a power transmission section that transmits the power to the antenna, and a power amplifier that amplifies the power on the circuit board. The transmission power is generally sent from the output terminal of the power amplifier to the antenna 16 via a feeding section.

In short, the antenna 16 of the portable telephone according to this embodiment is characterized by including the dielectric member 17 having a higher relative dielectric constant and lesser loss than the antenna of the related-art portable telephone (FIG. 14). Although the antenna 16 and the dielectric member 17 are disposed at the upper end of the upper casing 11 in FIGS. 1A and 1B, they may be disposed at the lower end of the lower casing 12.

### SECOND EMBODIMENT

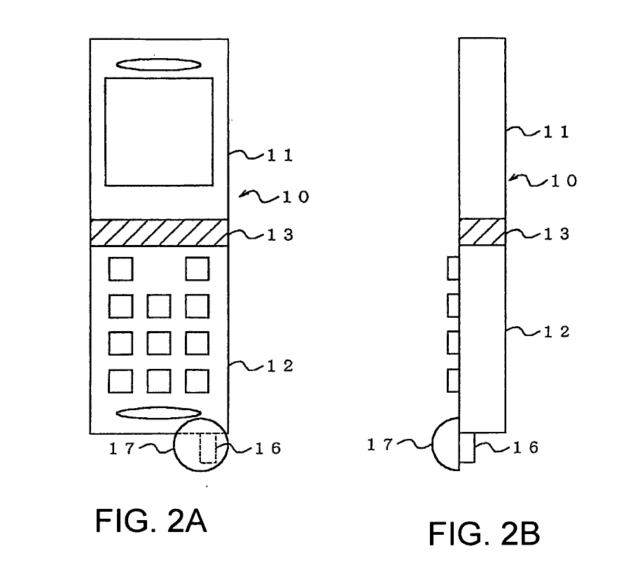

FIGS. 2A and 2B are a front view and a side view of a portable telephone according to a second embodiment of the present invention. As shown in FIGS. 2A and 2B, in this embodiment, the antenna 16 and the dielectric member 17 are disposed at the lower end of the lower casing 12 to reduce the influence of the palm of a hand.

In that case, the dielectric member 17 is disposed on the antenna from the front of the portable telephone 10, as shown in FIGS. 2A and 2B.

While in the first and second embodiments the antenna 16 projects outward from the casings 11 and 12, it may be built in the casing.

Although the antenna 16 has a monopole antenna structure in FIGS. 1A, 1B, 2A and 2B, it may have an inverted-L-shaped antenna structure. Also, while the dielectric member 17 is in shape of a hemisphere shape, it may be a dielectric member in shape of rectangular, a dielectric member in shape of hemicylinder, or other shapes having a curved surface.

### THIRD EMBODIMENT

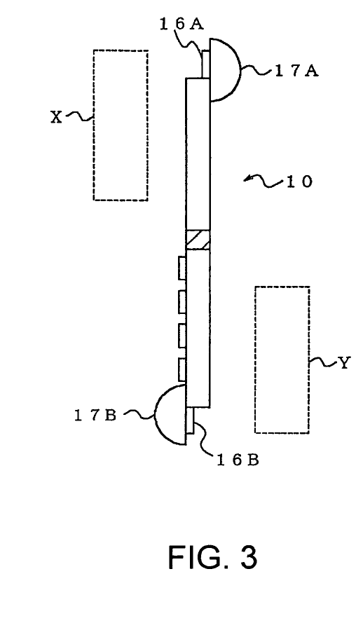

FIG. 3 is a side view of a portable telephone according to a third embodiment of the present invention. As shown in FIG. 3, a portable telephone 10 according to this embodiment has an antenna 16A and a dielectric member 17A on the upper casing or an antenna 16B and a dielectric member 17B on the lower casing. FIG. 3 shows the positional relationship between the head X and the palm Y of a talker. In this case, the antenna 16A and the dielectric member 17A can be replaced with the antenna 16B and the dielectric member 17B, only by the detachment thereof.

### FOURTH EMBODIMENT

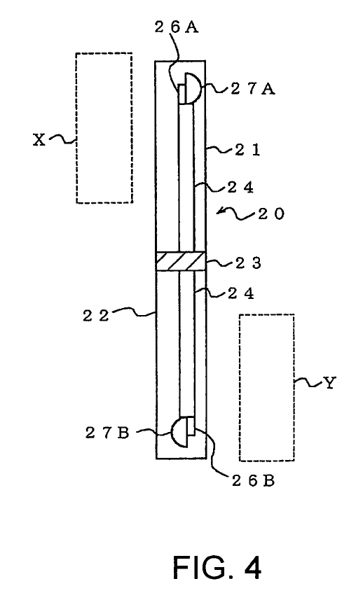

FIG. 4 is a side view of a portable telephone according to a fourth embodiment of the present invention. As shown in FIG. 4, a portable telephone 20 according to this embodiment has a structure in which the upper casing 21 and the lower casing 22 can be folded with the hinge 23 and antennas 26A and 26B and dielectric members 27A and 27B are built in.

In this case, the upper casing 21 includes the printed circuit board 24, at the upper end of which the antenna 26A and the dielectric member 27A are mounted.

Similarly, the lower casing 22 may include the printed circuit board 24, at the lower end of which the antenna 26B and the dielectric member 27B may be mounted.

In order to minimize the thickness of the portable telephone 20 of this embodiment, for the upper casing 21, the antenna 26A and the dielectric member 27A have only to be disposed on the front surface of the printed circuit board 24, or at a position close to the head X of the talker and, for the lower casing 22, the antenna 26B and the dielectric member 27B have only to be disposed on the back of the printed circuit board 24, or at a position close to the palm Y of the talker.

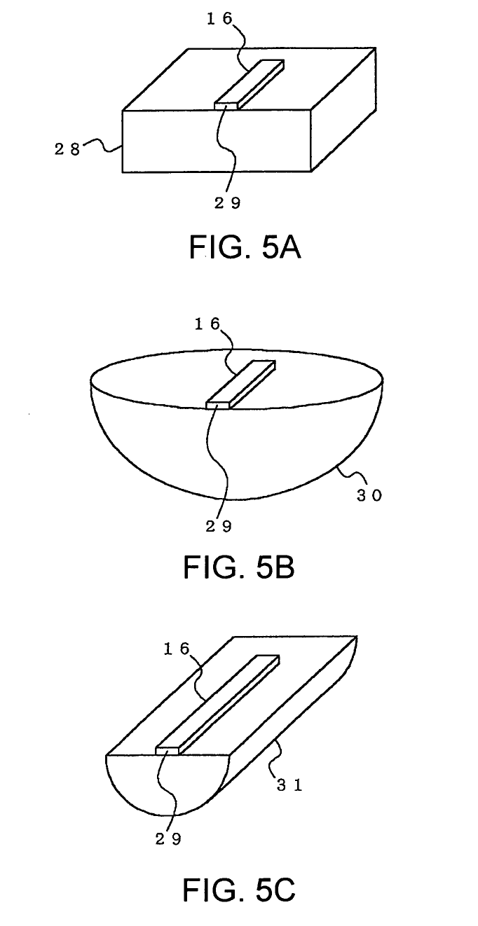

FIGS. 5A to 5C are diagrams showing various shaped dielectric members used in FIGS. 1 to 4. FIG. 5A shows an example in which a dielectric member in shape of rectangular 28 is used for the antenna 16. Numeral 29 denotes a joint with the casing of the portable telephone or a built-in board, serving as a feeding section for electricity supplied by the portable telephone body to the antenna 16.

Likewise, FIG. 5B shows an example in which a dielectric member in shape of hemisphere 30 is used for the antenna 16, and FIG. 5C shows an example in which a dielectric member in shape of hemicylinder 31 is used.

While the antenna 16 is a monopole antenna by way of example, an inverted-L-shaped antenna can also be mounted.

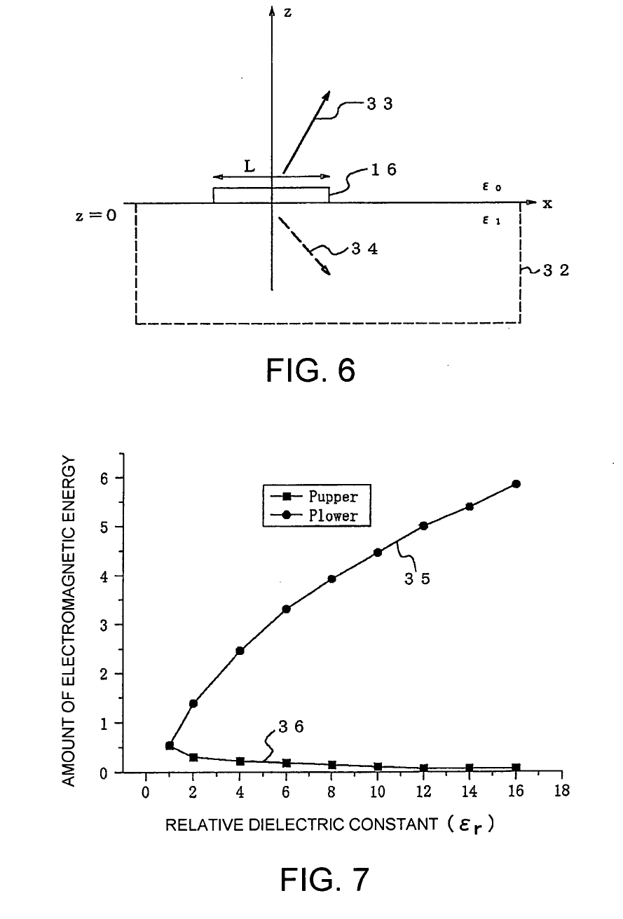

The principle of operation of the antenna having a dielectric member according to this embodiment will be described with reference to FIGS. 6 to 13.

FIG. 6 is an explanatory diagram of the three-dimensional orthogonal coordinates of a linear antenna model for explaining the principle of the present invention. As shown in FIG. 6, when the antenna 16 is mounted on a hemi-infinite space, on a dielectric member (dielectric constant: ε1) 32 in this case, most of the electromagnetic waves radiated from the antenna 16 having a length L are concentrated on the dielectric member 32, where ε0 is a dielectric constant in a vacuum.

In the three-dimensional orthogonal coordinate system, the lower hemisphere (z<0) is a hemi-infinite space (dielectric constant: ε1) having a relative dielectric constant εr=(ε1/ε0) [>1], and the upper hemisphere (z>0) is a vacuum hemi-infinite space (dielectric constant: ε0). The magnetic permeability is μ0 in the whole space. The antenna 16 is an L-long linear antenna located at the origin and in parallel with the x-axis. Suppose that a high-frequency current i having an angular frequency ω flows on the antenna 16.

In such a state, both of a magnetic wave 33 radiated to the upper hemisphere and a magnetic wave 34 radiated to the lower hemisphere will be discussed. The z-components of the electric field and the magnetic field in the position (x, y, z) of z>0 or z<0, or Ez and Hz, are expressed as equation (1) by plane-wave decomposition (refer to Chew “Waves and Fields in Inhomogeneous Media,” IEEE, ISBN 0-7803-4749-8):

$$\begin{matrix}\begin{matrix}{E}_{Z} = ( \frac{l1}{8 {π}^{2} ω {ɛ}_{0}} ) {\int \int }_{- ∞ < {k}_{x} , {k}_{y} < ∞} {k}_{x} exp ( ⅈ {k}_{x} x + ⅈ {k}_{y} y + ⅈ {k}_{0 z} z ) \{ 1 - {R}^{TM} \} ⅆ {k}_{x} ⅆ {k}_{y} \\ {H}_{z} = ( \frac{l1}{8 {π}^{2}} ) {\int \int }_{- ∞ < {k}_{x} , {k}_{y} < ∞} \frac{{k}_{y}}{{k}_{0 z}} exp ( ⅈ {k}_{x} x + ⅈ {k}_{y} y + ⅈ {k}_{0 z} z ) \{ 1 + {R}^{TM} \} ⅆ {k}_{x} ⅆ {k}_{y} \\ ( z > 0 ) \\ {E}_{z} = ( \frac{- l1}{8 {π}^{2} ω ɛ 1} ) {\int \int }_{- ∞ < {k}_{x} , {k}_{y} < ∞} {k}_{x} exp ( ⅈ {k}_{x} x + ⅈ {k}_{y} y - ⅈ {k}_{1 z} z ) {T}^{TM} ⅆ {k}_{x} ⅆ {k}_{y} \\ {H}_{z} = ( \frac{l1}{8 {π}^{2}} ) {\int \int }_{- ∞ < {k}_{x} , {k}_{y} < ∞} \frac{{k}_{y}}{{k}_{1 z}} exp ( ⅈ {k}_{x} x + ⅈ {k}_{y} y - ⅈ {k}_{1 z} z ) {T}^{TM} ⅆ {k}_{x} ⅆ {k}_{y} \\ ( z < 0 )\end{matrix} \} \\ where , \\ \begin{matrix}{R}^{TM} = \frac{{ɛ}_{1} {k}_{0 z} - {ɛ}_{0} {k}_{1 z}}{{ɛ}_{1} {k}_{0 z} + {ɛ}_{0} {k}_{1 z}} & & & {R}^{TE} = \frac{{k}_{0 z} - {k}_{1 z}}{{k}_{0 z} + {k}_{1 z}}\end{matrix} \\ \begin{matrix}{T}^{TM} = \frac{2 {ɛ}_{1} {k}_{0 z}}{{ɛ}_{1} {k}_{0 z} + {ɛ}_{0} {k}_{1 z}} & & & {T}^{TE} = \frac{2 {k}_{0 z}}{{k}_{0 z} + {k}_{1 z}}\end{matrix} \\ \begin{matrix} {k}_{{0}_{z}}^{2} = {k}_{0}^{2} - {k}_{x}^{2} - {k}_{y}^{2} & & & & {k}_{{1}_{z}}^{2} = {k}_{1}^{2} - {k}_{x}^{2} - {k}_{y}^{2}\end{matrix} \\ \begin{matrix} {k}_{0} = \sqrt{{ɛ}_{0} {μ}_{0} ω} & & & {k}_{1} = \sqrt{{ɛ}_{1} {μ}_{0} ω} \end{matrix} \\ {ɛ}_{r} = \frac{{ɛ}_{1}}{{ɛ}_{0}} > 1\end{matrix} \qquad ( 1 )$$

If z>0, the component of the integrated term of equation (1) indicates a plane wave that travels in the direction of the wave number vector (kx, ky, k0z), and if z<0, it indicates a plane wave that travels in the direction of the wave number vector (kx, ky, k1z). R^{TM} and R^{TE} indicate the reflection coefficients of the TM component and the TE component of a plane wave for z=0, respectively, and T^{TM} and T^{TE} indicate the transmission components of the same. The electric fields and the magnetic fields Ex, Ey, Hx, and Hy of the x- and y-components of the plane-wave components can be obtained by equation (2):

$$\begin{matrix}\begin{matrix}{E}_{x} \hat{x} + {E}_{y} \hat{y} = \frac{1}{{k}_{x}^{2} + {k}_{y}^{2}} [ ( \hat{x} \frac{\partial }{\partial x} + \hat{y} \frac{\partial }{\partial y} ) \frac{\partial {Ez}_{2}}{\partial z} ] + \\ j {ωμ}_{0} \hat{z} \times ( \hat{x} \frac{\partial }{\partial x} + \hat{y} \frac{\partial }{\partial y} ) {H}_{z}\end{matrix} \\ \begin{matrix}{H}_{x} \hat{x} + {H}_{y} \hat{y} = \frac{1}{{k}_{x}^{2} + {k}_{y}^{2}} [ ( \hat{x} \frac{\partial }{\partial x} + \hat{y} \frac{\partial }{\partial y} ) \frac{\partial {Ez}_{2}}{\partial z} ] - \\ j {ωμ}_{0} \hat{z} \times ( \hat{x} \frac{\partial }{\partial x} + \hat{y} \frac{\partial }{\partial y} ) {E}_{z}\end{matrix}\end{matrix} \} \qquad ( 2 )$$

where
\hat{x}: x-direction unit vector
ŷ: y-direction unit vector
\hat{z}: z-direction unit vector

FIG. 7 is a characteristic diagram of the amount of electromagnetic energy plotted against the relative dielectric constants of FIG. 6. As shown in FIG. 7, the amount Pᵤₚₚₑᵣ of electromagnetic energy traveling toward the upper hemisphere (z>0) and the amount P_{lower} of electromagnetic energy traveling toward the lower hemisphere (z<0) are expressed as equation (3):

$$\begin{matrix}{P}_{upper} = Re {\int \int }_{- ∞ < {k}_{x} , {k}_{y} < ∞} \hat{z} \cdot ( E \times {H}^{*} ⅆ {k}_{x} ⅆ {k}_{y} & ( z > 0 ) \\ {P}_{lower} = Re {\int \int }_{- ∞ < {k}_{x} , {k}_{y} < ∞} \hat{z} \cdot ( E \times {H}^{*} ⅆ {k}_{x} ⅆ {k}_{y} & ( z < 0 )\end{matrix} \} \\ where \begin{matrix}E = ( \begin{matrix}{E}_{x} \\ {E}_{y} \\ {E}_{z}\end{matrix} ) & & H = ( \begin{matrix}{H}_{x} \\ {H}_{y} \\ {H}_{z}\end{matrix} )\end{matrix} {\\ }^{*} \text{:} complex conjugate \qquad ( 3 )$$

FIG. 7 shows the values in equation (3) quantitatively, which are plotted with relative dielectric constant εr as abscissa against the amount of electromagnetic energy standardized by the entire electromagnetic energy radiated when the entire space is in a vacuum as ordinate, in which numeral 36 indicates a line characteristic indicative of the amount of electromagnetic energy radiated to the upper hemisphere and numeral 35 denotes a line characteristic indicative of the amount of electromagnetic energy radiated to the lower hemisphere.

FIG. 7 shows that, the higher the relative dielectric constant, the greater the ratio of the electromagnetic energy (P_{lower}) radiated to the lower hemisphere to the electromagnetic energy (Pᵤₚₚₑᵣ) radiated to the upper hemisphere. Accordingly, when a substance that may bring a loss, such as the human head X or hand palm Y, is present in the vicinity of the antenna 16, a dielectric member having a relative dielectric constant of 1 or more is mounted on the antenna 16 to fill the side opposite to the human body. This shape can concentrate more electromagnetic waves radiated from the antenna 16 on the side opposite to the human body than without the dielectric member, resulting in a relative decrease in electromagnetic energy loss due to the human body.

However, when the above-described principle of operation is applied to portable telephones, extraneous phenomena due to finite thickness must be taken into consideration because an infinite-thickness dielectric member cannot be mounted to the antenna 16. For example, a principal extraneous phenomenon is a surface wave. The surface wave is a component, of the plane wave components of z<0 expressed by the above-mentioned equation (1), whose angle of incidence defined by the dielectric member and the vacuum space is larger than the critical angle (θc) that satisfies equation (4):

$${θ}_{c} = {sin}^{- 1} ( \frac{1}{\sqrt{{ɛ}_{r}}} ) \qquad ( 4 )$$

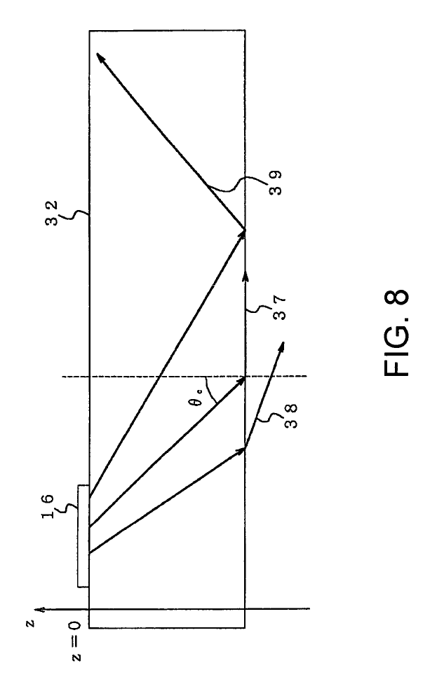

FIG. 8 is an enlarged view of a dielectric member, for explaining a refraction phenomenon around the critical angle of electromagnetic waves radiated from the antenna to a finite-thickness dielectric member in FIG. 6. FIG. 8 shows a state around the critical angle (θc) at which the electromagnetic waves generated from the antenna 16 propagate in the finite-thickness dielectric member 32. In FIG. 8, numeral 37 denotes a plane wave component whose angle of incidence is the critical angle, numeral 38 indicates a plane wave component whose angle of incidence is less than the critical angle and which is radiated into a vacuum, and numeral 39 indicates a plane wave component whose angle of incidence is larger than the critical angle and which becomes a surface wave. The surface wave does not carry the electromagnetic energy in the direction of z<0 but propagates on the x-y plane. However, since the dielectric member 32 mounted on the antenna 16 is finite in area also for the x-y plane, the generated surface wave is dispersed or reflected at the end.

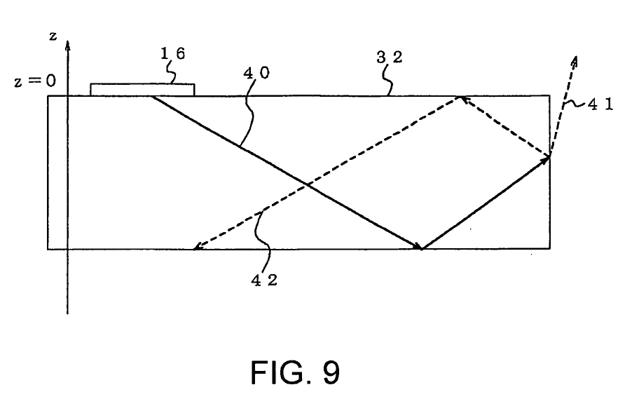

FIG. 9 is an enlarged view of a dielectric member for explaining reflection and refraction phenomena at the end of the dielectric member caused by a surface wave component traveling in the dielectric member in FIG. 8. As shown in FIG. 9, a surface wave component 40 is divided into a surface wave component 41 refracted by the dielectric member 32 into dispersion and a surface wave component 42 reflected into the dielectric member 32. The generation of the surface wave components 41 and the 42 may decrease the function of the dielectric member 32 as a directional antenna that radiates electromagnetic waves in the direction of z<0. A method for preventing the occurrence of the surface wave components 41 and 42 is to provide a curved surface on the dielectric member 32.

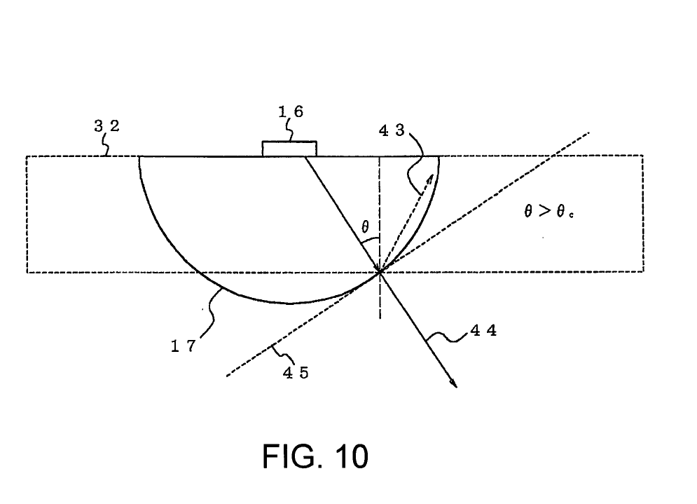

FIG. 10 is an enlarged view of a dielectric member for explaining a direction in which an electromagnetic wave travels when the dielectric member in FIG. 6 has a curved surface. As shown in FIG. 10, in the hemispherical dielectric member 17 structured by forming a curved surface on the dielectric member 32 shown in FIG. 9, there is a plane wave component 44 which passes outwardly through the dielectric member 17 and a plane wave component 43 which total-reflects at an incidence angle θ larger than a critical angle (θc) of the dielectric member 32 having no curved surface (θ>θc). A numeral 45 denotes a tangent. That is, when the curved surface is provided on the dielectric member 32, the incidence angle θ becomes less than the critical angle θc (θ<θc) and therefore the plane wave component 44 passes into a vacuum space. Although the dielectric member in shape of hemisphere having a curved surface is used in this case as an example having a curved surface, a dielectric member in shape of hemicylinder may offer the same effects. Also, other-shaped dielectric members having a curved surface provide the same effects.

Another additional effect caused by the finite thickness of the dielectric member 32 may be the generation of a component that is reflected by the surface of the dielectric member within the critical angle (εc), then passes through the surface (z=0) including the antenna 16, and is radiated to the upper hemisphere (z>0). This component has an amount depending on the thickness and size of the dielectric member, and so is hardly quantified theoretically. Accordingly, numerical simulation is used to optimize the dielectric constant and structure of a dielectric member to be mounted.

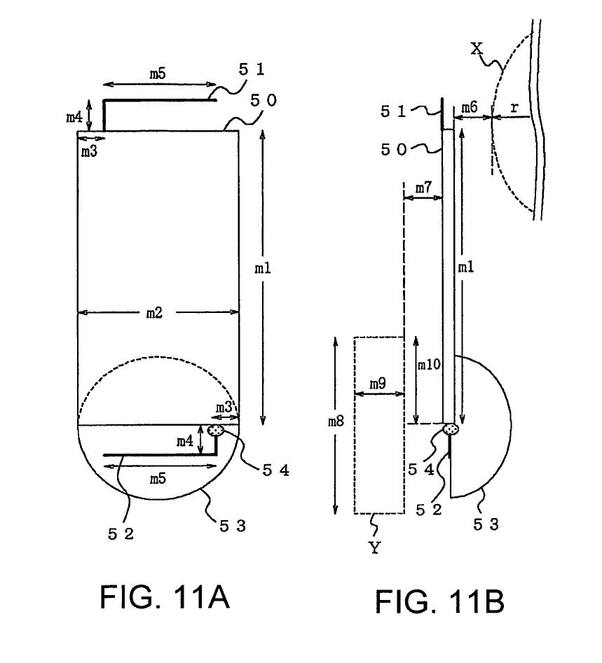

FIGS. 11A and 11B are a front view and a side view of a portable telephone for explaining a simulation model in which an inverted-L-shaped antenna is used in FIGS. 3 and 4. As shown in FIGS. 11A and 11B, the simulation model is a simplified model in which the effectiveness of the embodiment is verified by using finite difference time domain (FDTD). In FIGS. 11A and 11B, numeral 50 denotes a portable telephone, numeral 51 an inverted-L-shaped antenna mounted on the top of the casing, numeral 52 an inverted-L-shaped antenna mounted on the bottom of the casing, numeral 53 a dielectric member in shape of hemisphere, numeral 54 an antenna feeding section mounted to the bottom of the casing, symbol X a sphere having a radius r (=10 cm) that imitates the head of a talker, and symbol Y a rectangular prism that imitates the hand of the talker, wherein concrete values of m are m1=15 cm, m2=4 cm, m3=0.6 cm, m4=0.9 cm, m5=2.8 cm, m6=m7=1 cm, m8=10 cm, m9=2 cm, and m10=5 cm.

The portable telephone 50 for this analysis has a rectangle casing of 0 in thickness and has the inverted-L-shaped antennas 51 and 52 on the top and bottom.

More concrete model of the rectangular prism Y, imitation of a hand, of the portable telephone 50 will be described.

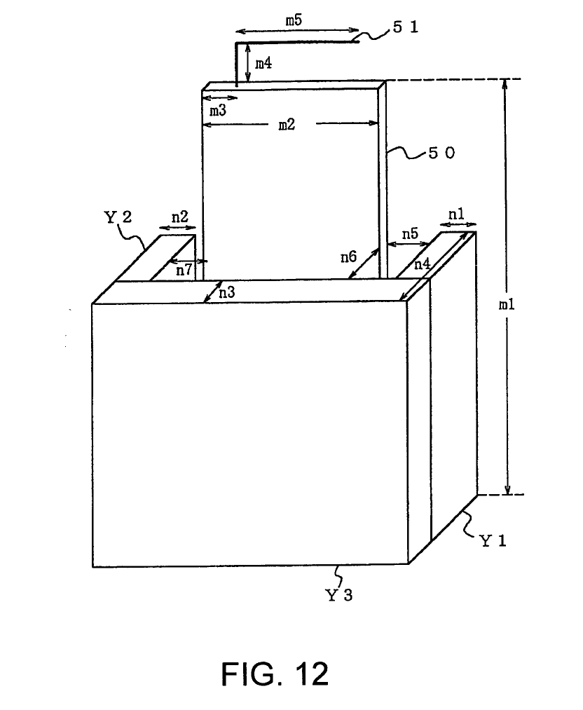

FIG. 12 is a perspective view of the portable telephone for explaining the simulation model in which the palm and fingers of the talker are imitated in FIGS. 11A and 11B. As shown in FIG. 12, the portable telephone 50 and the rectangular prism Y of the imitation of a hand in FIGS. 11A and 11B can be modeled practically in U shape. The rectangular prism Y is composed of rectangular prisms Y1 and Y2 that imitate the fingers and a rectangular prism Y3 that imitates the palm of a hand. Their concrete numerical values are n=n2=n3=2 cm, n4=4.0 cm, and n5=n6=n7=1 cm. Numerical values of m1 to m5 have been described in FIGS. 11A and 11B. In this drawing, the inverted-L-shaped antenna 52 mounted to the bottom of the casing is hidden by the palm Y3.

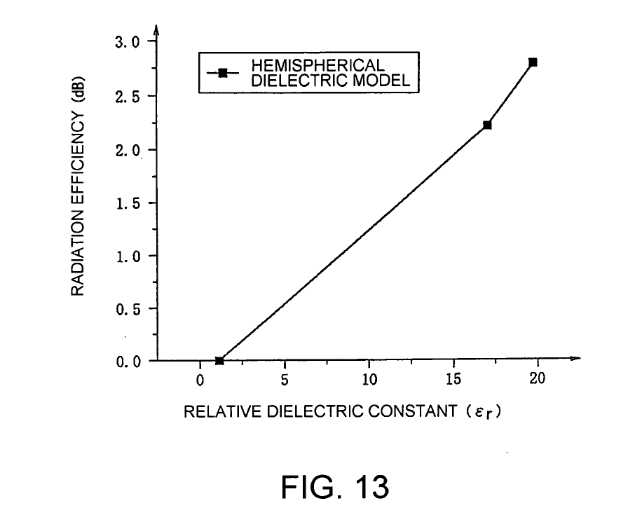

FIG. 13 is a characteristic diagram of the relationship between relative dielectric constants and electromagnetic radiation efficiencies for explaining the analysis of the simulation model in FIGS. 11A, 11B, and 12. As shown in FIG. 13, the simulation model using the hemispherical dielectric member is the analysis of the radiation efficiency of an antenna in the case in which the relative dielectric constant of the head is 43.2, the conductivity is 1.25 (S/m), the relative dielectric constant of the hand is 36.1, the conductivity is 1.0 (S/m), the casing and the antenna are given perfect conductivity, the relative dielectric constant of a dielectric member mounted to the antenna is set at 1, 17, 20, the conductivity is set at 0, and an alternating voltage of 1V is applied only to the antenna mounted to the bottom of the casing at a frequency of 2 GHz. A relative dielectric constant of 1 is equal to that of an antenna without a dielectric member. FIG. 13 shows radiation efficiency increment with the radiation efficiency for a relative dielectric constant of 1 as the reference (0 dB) in decibel. This clearly shows that the radiation efficiency (dB) of the antenna of this model depends heavily on the relative dielectric constant of the dielectric member.

For example, in this hemispherical dielectric member model, the radiation efficiency of the antenna is increased to a level about 2 dB higher than that without a dielectric member, or when the relative dielectric constant is set at 1 (0 dB), by setting the relative dielectric constant of the dielectric member at 17 (approximately 2.2 dB) or 20 (approximately 2.7 dB).

As has been described, since the portable telephone according to the present invention can provides a transmission antenna with a power loss due to a human body small by mounting a dielectric member with a relatively high relative dielectric constant and little loss on the opposite side of a section covered by the head or the hand of a talker, or in some cases, by providing a curved surface on the dielectric member, the advantages of providing a higher antenna gain during talking and therefore of improving the talking performance of a portable telephone.

It will be obvious to those skilled in the art that the present invention is not limited to the above-described embodiments but the embodiments can be modified variously within the sprit and scope of the present invention.

1. A portable telephone comprising an upper casing provided with a speaker and a display screen and a lower casing on which a keyboard is disposed, wherein an antenna is mounted on at least one of an upper end of the upper casing and a lower end of the lower casing, wherein
a dielectric member with a predetermined dielectric constant and little loss is mounted on a back side or a front side of the antenna.

2. The portable telephone according to claim 1, wherein the dielectric member is a dielectric member in shape of hemisphere.

3. The portable telephone according to claim 1, wherein the dielectric member is a dielectric member in shape of hemicylinder.

4. The portable telephone according to claim 1, wherein the dielectric member is a dielectric member in shape of rectangular.

5. The portable telephone according to claim 1, wherein the dielectric member has a curved surface on a side opposite to the antenna.

6. The portable telephone according to claim 1, wherein the antenna is a built-in antenna built in the upper casing or the lower casing.

7. The portable telephone according to claim 1, wherein the antenna is a dipole antenna.

8. The portable telephone according to claim 1, wherein the antenna is an inverted-L-shaped antenna.

9. The portable telephone according to claim 1, wherein the antenna is a monopole antenna.

10. The portable telephone according to claim 1, wherein the antenna is a meander antenna.
